(19) United States
(12) Patent Application Publication
(10) Pub. No.: US 2019/0281830 A1
(43) Pub. Date: Sep. 19, 2019

(54) CO-FORMULATIONS OF BIFENTHRIN WITH HIGH-MELTING CROP PROTECTION AGENTS FOR USE WITH LIQUID FERTILIZERS

(71) Applicant: FMC Corporation, Philadelphia, PA (US)

(72) Inventor: Timothy M. Martin, Ringoes, NJ (US)

(21) Appl. No.: 16/429,417

(22) Filed: Jun. 3, 2019

Related U.S. Application Data
(63) Continuation of application No. 14/217,549, filed on Mar. 18, 2014, now abandoned.
(60) Provisional application No. 61/887,100, filed on Oct. 4, 2013.

(51) Int. Cl. A01N 53/00; A01N 43/90; C05G 3/02

(52) U.S. Cl. CPC A01N 53/00; C05G 3/02; A01N 43/90

(57) ABSTRACT

Insecticidal compositions suitable for use in preparation of insecticidal liquid fertilizers are disclosed, the compositions comprising bifenthrin, at least one other unencapsulated crop protection agent having a melting point of about 50° C. or greater, a hydrated aluminum-magnesium silicate, and at least one dispersant selected from the group consisting of a sucrose ester, a lignosulfonate, an alkylpolyglycoside, a naphthalenesulfonic acid formaldehyde condensate and a phosphate ester.

### CROSS-REFERENCE TO RELATED APPLICATIONS

This application is a continuation of U.S. patent application Ser. No. 14/217,549, filed Mar. 18, 2014, which claims the benefit under 35 U.S.C. § 119(e) of U.S. Provisional Application Ser. No. 61/887,100, filed Oct. 4, 2013, the disclosures of all of which are incorporated herein by reference in their entireties.

### FIELD OF THE INVENTION

The present invention relates to the field of agrochemical compositions and formulations. In particular, the invention provides an insecticidal composition comprising a bifenthrin in combination with an unencapsulated high-melting crop protection agent, where the composition is suitable for use in the preparation of insecticidal liquid fertilizers.

### BACKGROUND OF THE INVENTION

To enable the efficient elimination or control of unwanted insects in combination with providing nutrients for plants to combat adverse environmental conditions (such as heat, drought, physical contact with animals, etc.) it is desirable to formulate an effective chemical insecticide for use in preparation of insecticidal liquid fertilizers. Formulations of insecticides combined with fertilizers are desirable in agricultural and related endeavors due to the multiple benefits conveyed by just one application in a single piece of equipment. One application of such a combination or formulation provides nutrients for the plant growth, while eliminating or controlling unwanted insects that can also affect the health and vitality of the desirable plants.

Mixtures containing insecticide compositions and liquid fertilizers have been practiced in the art, but problems with the physical stability of such mixtures have caused application and efficacy issues. When a traditional insecticidal composition is combined with a liquid fertilizer, the combined components (surfactants, viscosity modifiers, wetting agents) of both can cause accelerated physical degradation (phase separation) of the mixture. This physical degradation can occur in the mix tanks prior to application on the plants. Often this problem goes unnoticed and results in inconsistent application of both the fertilizer and insecticide, yielding inadequate efficacy of both.

### SUMMARY OF THE INVENTION

In one aspect, the present invention is directed to an insecticidal composition comprising a) bifenthrin; b) at least one unencapsulated crop protection agent other than bifenthrin, having a melting point of about 50° C. or greater; c) a hydrated aluminum-magnesium silicate; and d) at least one dispersant selected from the group consisting of a sucrose ester, a lignosulfonate, an alkylpolyglycoside, a naphthalenesulfonic acid formaldehyde condensate and a phosphate ester. Preferably, the insecticidal composition comprises a) about 1% to about 35% of bifenthrin; b) about 1% to about 35% of at least one unencapsulated insecticide other than bifenthrin, having a melting point of about 50° C. or greater; c) about 1% to about 20% of hydrated aluminum-magnesium silicate; and d) about 0.2% to about 20% of at least one dispersant selected from the group consisting of a sucrose ester, a lignosulfonate, an alkylpolyglycoside, a naphthalenesulfonic acid formaldehyde condensate and a phosphate ester; where all % are % by weight based upon the total weight of all components in the composition.

Preferably the unencapsulated crop protection agent is an unencapsulated fungicide or an unencapsulated insecticide other than bifenthrin.

In one embodiment, the unencapsulated insecticide other than bifenthrin is selected from abamectin, aldicarb, bendiacarb, carbaryl, carbofuran, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron, buprofezin, cyromazine, methoxyfenozide, chromafenozide, amitraz, indoxacarb, azadirachtin and pyridaben. In one particular embodiment, the unencapsulated insecticide other than bifenthrin is abamectin.

In one embodiment, the unencapsulated fungicide is selected from of bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole, pefurazoate, imazalil, triflumizole, cyazofamid, benomyl, carbendazim, thiabendazole, fuberidazole, ethaboxam, etridiazole and hymexazole, azaconazole, diniconazole-M, oxpoconazol, paclobutrazol, uniconazol, imazalilsulfphate, azoxystrobin, dimoxystrobin, fluoxastrobin, kresoxim-methyl, orysastrobin, picoxystrobin, pyraclostrobin, trifloxystrobin, enestroburin, carboxin, benalaxyl, benalaxyl-M, fenhexamid, flutolanil, furametpyr, mepronil, metalaxyl, mefenoxam, ofurace, oxadixyl, oxycarboxin, penthiopyrad, isopyrazam, thifluzamide, tiadinil, dimethomorph, flumorph, fluopicolide (picobenzamid), zoxamide, carpropamid, diclocymet, mandipropamid, bixafen, fluazinam, cyprodinil, fenarimol, ferimzone, mepanipyrim, nuarimol, pyrimethanil, fenpiclonil, fludioxonil, aldimorph, dodemorph, fenpropimorph, iprodione, procymidone, vinclozolin, famoxadone, fenamidone, probenazole, acibenzolar-S-methyl, captafol, captan, dazomet, folpet, fenoxanil, quinoxyfen, nitrapyrin, fluoroimid, blasticidin-S, chinomethionat, difenzoquat-methylsulphate, oxolinic acid, mancozeb, maneb, methasulphocarb, metiram, ferbam, propineb, thiram, zineb, ziram, diethofencarb, iprovalicarb, benthiavalicarb, propamocarb hydrochloride, guanidine, dodine, kasugamycin, validamycin A, binapacryl, dinobuton, dithianon, isoprothiolane, fosetyl-aluminum, pyrazophos, tolclofos-methyl, dichlofluanid, flusulfamide, hexachlorobenzene, phthalide, pencycuron, quintozene, thiophanate-methyl, tolylfluanid, cyflufenamid, cymoxanil, ethirimol, furalaxyl, metrafenone, iminoctadine-triacetate, iminoctadine-tris(albesilate), kasugamycin hydrochlorid-hydrat, dichlorophen, pentachlorophenol and its salts, dicloran, nitrothal-isopropyl, tecnazen, biphenyl, bronopol, diphenylamine, mildiomycin, oxine-copper and prohexadione calcium.

In one embodiment, the hydrated aluminum-magnesium silicate is selected from montmorillonite and attapulgite. Preferably the hydrated aluminum-magnesium silicate is attapulgite. In another embodiment, the phosphate ester is selected from a nonyl phenol phosphate ester and a tridecyl alcohol ethoxylated phosphate salt. Preferably the phosphate ester is a tridecyl alcohol ethoxylated phosphate potassium salt.

Another aspect of the invention is directed to an insecticidal liquid fertilizer composition wherein the insecticidal composition further comprises a liquid fertilizer. Preferably, the liquid fertilizer is aqueous-based. In one embodiment, the liquid fertilizer is present in a concentration of about 95.0% by weight to about 99.99% by weight based on the total weight of all components in the composition. Preferably, the other components of the insecticidal liquid fertilizer composition include bifenthrin in about 0.75% to about 1.25%, the unencapsulated high-melting insecticide in about 0.75% to about 1.25%, the hydrated aluminum-magnesium silicate in about 0.05% to about 1.0%, and the dispersant in about 0.1% to about 0.75% by weight based on the total weight of all components in the composition.

In yet another embodiment, the above compositions further include at least one of an anti-freeze agent, an anti-foam agent and a biocide.

### DETAILED DESCRIPTION OF THE INVENTION

In accordance with the present invention, it has now been found that a new insecticidal composition significantly improves physical stability when used to prepare an insecticidal liquid fertilizer. Accordingly, the present invention is directed to an insecticidal composition that includes bifenthrin, an additional unencapsulated high-melting crop protection agent, a hydrated aluminum-magnesium silicate, and at least one dispersant selected from the group consisting of a sucrose ester, a lignosulfonate, an alkylpolyglycoside, a naphthalenesulfonic acid formaldehyde condensate and a phosphate ester.

As used in this specification and unless otherwise indicated the term “crop protection agent” refers to a molecule or combination of molecules which express biological activity as a pesticide, arthropodicide, insecticide, acaricide, nematocide, fungicide, herbicide, plant growth regulator or a combination of two or more of these biological activities. As used in this specification and unless otherwise indicated, the term “insecticide” refers to a molecule or combination of molecules that repels, retards, or kills insects, and can be used for crop protection, edifice protection, turf protection, or protection of a person. The term “liquid fertilizer” refers to a fertilizer in a fluid or liquid form containing various ratios of nitrogen, phosphorous and potassium (for example, but not limited to, 10% nitrogen, 34% phosphorous and 0% potassium) and micronutrients, commonly known as starter fertilizers that are high in phosphorus and promote rapid and vigorous root growth. Liquid fertilizers are commonly aqueous-based. As used herein, the term “aqueous-based” indicates that the predominant solvent or vehicle is water. The term “ambient temperature” as utilized herein shall mean any suitable temperature found in a laboratory or other working environment, and is generally not below about 15° C. nor above about 30° C.

The modifier “about” is used herein to indicate that certain preferred operating ranges, such as ranges for molar ratios for reactants, material amounts, and temperature, are not fixedly determined. The meaning will often be apparent to one of ordinary skill. For example, a recitation of a temperature range of about 120° C. to about 135° C. in reference to, for example, an organic chemical reaction would be interpreted to include other like temperatures that can be expected to favor a useful reaction rate for the reaction, such as 105° C. or 150° C. Where guidance from the experience of those of ordinary skill is lacking, guidance from the context is lacking, and where a more specific rule is not recited below, the “about” range shall be not more than 10% of the absolute value of an end point or 10% of the range recited, whichever is less.

Besides bifenthrin, other high-melting pyrethroids can be employed in the present invention. The preferred high-melting pyrethroids include, without limitation, bifenthrin, cypermethrin, beta-cypermethrin, deltamethrin, cis-permethrin, gamma-cyhalothrin, tralomethrin, cyfluthrin, beta-cyfluthrin, esfenvalerate and fluvalinate; more particularly, the pyrethroid is bifenthrin. For the purposes of the present invention, a “high melting” compound has a melting point of about 50° C. or greater, and a “low melting” compound has a melting point of <50° C. The pyrethroid is preferably present in a concentration of from about 1% by weight to about 35% by weight, more particularly, from about 15% by weight to about 25% by weight based upon the total weight of all components in the composition. In one embodiment, the high-melting pyrethroid is bifenthrin. Preferably, the high-melting pyrethroid is unencapsulated. In another embodiment, the high-melting pyrethroid is unencapsulated bifenthrin.

In one embodiment, the unencapsulated high-melting crop protection agent is an insecticide or fungicide, present in an insecticidally or fungicidally effective amount. Preferred insecticides are selected from the group consisting of abamectin, aldicarb, bendiacarb, carbaryl, carbofuran, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron, buprofezin, cyromazine, methoxyfenozide, chromafenozide, amitraz, indoxacarb, azadirachtin and pyridaben. Preferred fungicides are selected from the group consisting of bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole, pefurazoate, imazalil, triflumizole, cyazofamid, benomyl, carbendazim, thiabendazole, fuberidazole, ethaboxam, etridiazole and hymexazole, azaconazole, diniconazole-M, oxpoconazol, paclobutrazol, uniconazol, imazalilsulfphate, azoxystrobin, dimoxystrobin, fluoxastrobin, kresoxim-methyl, orysastrobin, picoxystrobin, pyraclostrobin, trifloxystrobin, enestroburin, carboxin, benalaxyl, benalaxyl-M, fenhexamid, flutolanil, furametpyr, mepronil, metalaxyl, mefenoxam, ofurace, oxadixyl, oxycarboxin, penthiopyrad, isopyrazam, thifluzamide, tiadinil, dimethomorph, flumorph, fluopicolide (picobenzamid), zoxamide, carpropamid, diclocymet, mandipropamid, bixafen, fluazinam, cyprodinil, fenarimol, ferimzone, mepanipyrim, nuarimol, pyrimethanil, fenpiclonil, fludioxonil, aldimorph, dodemorph, fenpropimorph, iprodione, procymidone, vinclozolin, famoxadone, fenamidone, probenazole, acibenzolar-S-methyl, captafol, captan, dazomet, folpet, fenoxanil, quinoxyfen, nitrapyrin, fluoroimid, blasticidin-S, chinomethionat, difenzoquat-methylsulphate, oxolinic acid, mancozeb, maneb, methasulphocarb, metiram, ferbam, propineb, thiram, zineb, ziram, diethofencarb, iprovalicarb, benthiavalicarb, propamocarb hydrochloride, guanidine, dodine, kasugamycin, validamycin A, binapacryl, dinobuton, dithianon, isoprothiolane, fosetyl-aluminum, pyrazophos, tolclofos-methyl, dichlofluanid, flusulfamide, hexachlorobenzene, phthalide, pencycuron, quintozene, thiophanate-methyl, tolylfluanid, cyflufenamid, cymoxanil, ethirimol, furalaxyl, metrafenone, iminoctadine-triacetate, iminoctadine-tris(albesilate), kasugamycin hydrochlorid-hydrat, dichlorophen, pentachlorophenol and its salts, dicloran, nitrothal-isopropyl, tecnazen, biphenyl, bronopol, diphenylamine, mildiomycin, oxine-copper and prohexadione calcium.

The hydrated aluminum-magnesium silicate is preferably selected from montmorillonite and attapulgite. The phosphate ester dispersant is preferably selected from a nonyl phenol phosphate ester and a tridecyl alcohol ethoxylated phosphate potassium salt.

The dispersant or dispersants are preferably present in a total concentration of from about 0.02% by weight to about 20% by weight based upon the total weight of all components in the composition.

Optionally, the composition further includes at least one additive selected from anti-freeze agents, anti-foam agents and biocides. These formulation components are well-known in the agrochemical arts. In one embodiment, the anti-freeze agent is a polyalkylene glycol, preferably propylene glycol, and when present, is present in an amount from about 5% to about 9% by weight of the total of all components in the composition. In an embodiment, the anti-foam agent is an alkylcyclotetrasiloxane, preferably an octamethylcyclo-tetrasiloxane silicone emulsion, for example, DOW CORNING® AF Emulsion or DOWCORNING® ANTIFOAM C Emulsion (Dow Corning Corporation). When present, the anti-foam agent is present in an amount of from about 0.001% to about 1% by weight of all the components in the total formulation. The preservative can be an isothiazolone or a mixture of isothiazolones, for example, KATHON® CG/ICP preservative or LEGEND® MK preservative (Rohm and Haas Corporation) or PROXEL′ BR preservative (Avecia Corporation). When present, the preservative is present in an amount of from about 0.001% to about 1% by weight of the total of all components in the formulation.

Another embodiment of the present invention is a composition that includes a high-melting pyrethroid, an unencapsulated high-melting crop protection agent, a hydrated aluminum-magnesium silicate, at least one dispersant selected from a sucrose ester, a lignosulfonate, an alkylpolyglycoside, a naphthalenesulfonic acid formaldehyde condensate and a phosphate ester and a liquid fertilizer. The liquid fertilizer is preferably present in a concentration of from about 95.00% by weight to about 99.99% by weight based upon the total weight of all components in the formulation. The composition can further include at least one of an anti-freeze agent, an anti-foam agent and a biocide. Preferably, the high-melting pyrethroid is bifenthrin. Preferably, the unencapsulated high-melting crop protection agent is an insecticide selected from abamectin, aldicarb, bendiacarb, carbaryl, carbofuran, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron, buprofezin, cyromazine, methoxyfenozide, chromafenozide, amitraz, indoxacarb, azadirachtin and pyridaben.

An especially preferred embodiment of the present invention is an insecticidal composition that includes from about 15% to about 30% of bifenthrin, about 15% to about 30% of an unencapsulated high-melting crop protection agent, from about 1% to about 20% of hydrated aluminum-magnesium silicate and from about 0.02% to about 20% of at least one dispersant selected from a sucrose ester, a lignosulfonate, an alkylpolyglycoside, a naphthalenesulfonic acid formaldehyde condensate and a phosphate ester, wherein all % are % by weight based upon the total weight of all components in the composition. Preferably, the unencapsulated high-melting crop protection agent is an insecticide selected from abamectin, aldicarb, bendiacarb, carbaryl, carbofuran, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron, buprofezin, cyromazine, methoxyfenozide, chromafenozide, amitraz, indoxacarb, azadirachtin and pyridaben.

Another especially preferred embodiment of the present invention is an insecticidal fertilizer composition that includes from about 0.75% to about 1.25% of bifenthrin, about 0.75% to about 1.25% of an unencapsulated high-melting crop protection agent, from about 0.05% to about 1.0% of hydrated aluminum-magnesium silicate, from about 0.1% to about 0.75% of at least one dispersant selected from a sucrose ester, a lignosulfonate, an alkylpolyglycoside, a naphthalenesulfonic acid formaldehyde condensate and a phosphate ester, and from about 95% to about 99.99% of a liquid fertilizer, wherein all % are % by weight based upon the total weight of all components in the composition. Preferably, the unencapsulated high-melting crop protection agent is an insecticide selected from abamectin, aldicarb, bendiacarb, carbaryl, carbofuran, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron, buprofezin, cyromazine, methoxyfenozide, chromafenozide, amitraz, indoxacarb, azadirachtin and pyridaben.

The present invention also encompasses a method of controlling unwanted insects and providing nutrients to plants, the method includes applying to an area infested with such insects and containing such plants an effective amount of a liquid fertilizer in combination with one of the compositions of this invention.

The present invention further encompasses a process for preparing a composition according to the present disclosure by dispersing a high-melting pyrethroid and an unencapsulated second high-melting crop protection agent in a mixture of water and at least one dispersant, and optionally an anti-freeze agent, an anti-foam agent and a biocide; wet milling the mixture to an average particle size of about 0.1 to about 10 microns, preferably about 1 to about 5 microns, and adding a hydrated aluminum-magnesium silicate. The process can further include the step of adding the resultant mixture to a liquid fertilizer. Preferably, the high-melting pyrethroid is bifenthrin. Preferably, the unencapsulated high-melting crop protection agent is an insecticide selected from abamectin, aldicarb, bendiacarb, carbaryl, carbofuran, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron, buprofezin, cyromazine, methoxyfenozide, chromafenozide, amitraz, indoxacarb, azadirachtin and pyridaben.

The compositions of the present invention are further illustrated by the examples below. These examples serve only to illustrate the invention and should not be interpreted as limiting the scope of the invention in any way, since further modifications encompassed by the disclosed invention will be apparent to those skilled in the art. All such modifications are deemed to be within the scope of the invention as defined in the present specification and claims.

### EXAMPLES

### Example 1. Preparation of a Composition (Composition A) that Includes Bifenthrin and Abamectin

An amount of 330.75 grams of water was combined with 66.50 grams of propylene glycol, 38.50 grams of tridecyl alcohol ethoxylated phosphate potassium salt (DEXTROL® OC-180, Dexter Chemical Corp, Bronx, N.Y.), 42.00 grams of C₉-C₁₁ alkyl d-glucopyranoside (AGNIQUE® PG9116, BASF Corporation), 1.05 grams of polydimethylsiloxane (DOWCORNING® AF, Dow Corning Corp, Midland, Mich.), 0.70 grams of an isothiazodone compound (KATHON® CG/ICP, Rohm and Haas Co., Philadelphia, Pa.), and 3.50 grams of lignosulfonate sodium salt (REAX® 88B, MeadWestcaco), and the mixture was agitated. To this mixture was added 91.0 grams of bifenthrin (98 weight % active ingredient) with agitation. To the resulting mixture was added 63.00 grams of abamectin (99 weight % active ingredient), and the mixture was agitated. The resultant mixture was milled to less than 7 microns and then 63.00 grams of attapulgite clay (ATTAFLOW® FL, Englehard Corp., Iselin N.J.) was added to modify the final viscosity and produce a composition of the present invention.

### Example 2. Comparative Stability Study

This example sets forth stability studies that were performed on compositions prepared in accordance with the present invention.

The physical stability of Composition A of Example 1 was tested by mixing the composition with a 10% nitrogen-34% phosphorus-0% potassium aqueous-based liquid fertilizer at a 5% active ingredient ratio (5 mL of Composition A and 95 mL of 10-34-0 aqueous liquid fertilizer), and observing the mixture's physical stability in a 500 mL/50 cm column. The stability of Composition A was compared with that of two known formulations of bifenthrin, an Emulsifiable Concentrate (EC; TALSTAR® 2EC from FMC Corp.), and a Suspension Concentrate (SC; TALSTAR® 80F from FMC Corp.). The bifenthrin EC slowly but consistently floated to the top, as did the bifenthrin SC formulation. With the SC formulation, the sample floated to the top more quickly thereby concentrating in the samples taken after 20 minutes. See data in Table 1.

TABLE 1
Physical stability; ppm of bifenthrin in sample over time

| | | | 20 | | 40 | | 60 |
|---|---|---|---|---|---|---|---|
| | 0 min | 10 min | min | 30 min | min | 50 min | min |
| Composition A | 5919 | 5300 | 5364 | 5403 | 5370 | 5573 | 6605 |
| Bifenthrin SC | 4537 | 694 | 783 | 1962 | 3324 | 4289 | 6745 |
| Bifenthrin EC | 9427 | 7557 | 7052 | 5630 | 4270 | 2984 | 2757 |

The test data above indicates that the composition of Example 1 is homogenous throughout the test, indicating good physical stability, whereas the comparison formulations are not homogenous and have poor physical stability when mixed with high phosphorus aqueous-based liquid fertilizer.

While this invention has been described with an emphasis upon preferred embodiments, it will be obvious to those of ordinary skill in the art that variations in the preferred compositions and methods can be used and that it is intended that the invention can be practiced otherwise than as specifically described herein. Accordingly, this invention includes all modifications encompassed within the spirit and scope of the invention as defined by the claims that follow.

1-15. (canceled)

16. An insecticidal composition comprising:
a) bifenthrin;
b) a second agricultural active ingredient selected from the group consisting of abamectin, pyraclostrobin, fluoxastrobin, and mixtures of two or more thereof;
c) a hydrated aluminum-magnesium silicate;
d) an alkylpolyglycoside;
e) a phosphate ester salt;
f) a lignosulfonate salt;
g) propylene glycol;
h) an antifoaming agent;
i) a preservative; and
j) water.

17. The insecticidal composition of claim 16, wherein said hydrated aluminum-magnesium silicate is attapulgite clay, said alkylpolyglycoside is an alkyl d-glucopyranoside, said phosphate ester salt is a tridecyl alcohol ethoxylated phosphate salt, said antifoaming agent is polydimethylsiloxane, and said preservative is an isothiazolone or mixture of isothiazolones.

18. The insecticidal composition of claim 17, wherein said alkyl d-glucopyranoside is C₉-C₁₁ alkyl d-glucopyranoside, and said tridecyl alcohol ethoxylated phosphate salt is the potassium salt.

19. The insecticidal composition of claim 16, wherein said lignosulfonate salt is the sodium salt.

20. The insecticidal composition of claim 16, wherein bifenthrin is present in about 1% to about 35%; abamectin, pyraclostrobin, fluoxastrobin or mixture thereof is present in about 1% to about 35%; the hydrated aluminum-magnesium silicate is present in about 1% to about 20%; components d), e) and f) are present in a total of about 0.2% to about 20%; propylene glycol is present in about 5% to about 9.5%; and the preservative is present in about 0.001% to about 1% by weight based on the total weight of all components in the composition.

21. The insecticidal composition of claim 16, further comprising a liquid fertilizer in at least about 95 wt % based on the total composition, to provide a homogeneous insecticidal composition that is physically stable.

22. The homogeneous insecticidal composition of claim 21, wherein said liquid fertilizer is an aqueous-based high phosphorus fertilizer.

23. The homogeneous insecticidal composition of claim 22, wherein said high phosphorus fertilizer contains 10% nitrogen, 34% phosphorous, and 0% potassium.

24. The homogeneous insecticidal composition of claim 21, wherein bifenthrin is present in about 0.75% to about 1.25%; abamectin, pyraclostrobin, fluoxastrobin or mixture thereof is present in about 0.75% to about 1.25%; the hydrated aluminum-magnesium silicate is present in about 0.05% to about 1.0%; components d), e) and f) are present in a total of about 0.1% to about 0.75%; and propylene glycol is present in about 0.25% to about 0.45% by weight based on the total weight of all components in the composition.

25. A homogeneous insecticidal composition comprising:
i) a composition comprising:
a) bifenthrin;
b) abamectin;
c) a hydrated aluminum-magnesium silicate;
d) an alkylpolyglycoside;
e) a phosphate ester salt;
f) a lignosulfonate salt;
g) propylene glycol;
h) an antifoaming agent;
i) a preservative; and
j) water;
and
ii) a liquid fertilizer;
wherein said homogeneous insecticidal composition is physically stable.

26. The homogeneous insecticidal composition of claim 25, wherein said hydrated aluminum-magnesium silicate is attapulgite clay, said alkylpolyglycoside is an alkyl d-glucopyranoside, said phosphate ester salt is a tridecyl alcohol ethoxylated phosphate salt, said antifoaming agent is polydimethylsiloxane, and said preservative is an isothiazolone or mixture of isothiazolones.

27. The homogeneous insecticidal composition of claim 26, wherein said alkyl d-glucopyranoside is C₉-C₁₁ alkyl d-glucopyranoside.

28. The homogeneous insecticidal composition of claim 26, wherein said tridecyl alcohol ethoxylated phosphate salt is the potassium salt.

29. The homogeneous insecticidal composition of claim 25, wherein said lignosulfonate salt is the sodium salt.

30. The homogeneous insecticidal composition of claim 25, wherein bifenthrin is present in about 0.75% to about 1.25%; abamectin is present in about 0.75% to about 1.25%; the hydrated aluminum-magnesium silicate is present in about 0.05% to about 1.0%; components d), e) and f) are present in a total of about 0.1% to about 0.75%; and propylene glycol is present in about 0.25% to about 0.45% by weight based on the total weight of all components in the composition.

31. The homogeneous insecticidal composition of claim 25, wherein said liquid fertilizer is aqueous-based.

32. The homogeneous insecticidal composition of claim 31, wherein said aqueous-based liquid fertilizer is a high phosphorus fertilizer.

33. The homogeneous insecticidal composition of claim 32, wherein said high phosphorus fertilizer contains 10% nitrogen, 34% phosphorous, and 0% potassium.
